(19) United States
(12) Patent Application Publication
(10) Pub. No.: US 2024/0155676 A1
(43) Pub. Date: May 9, 2024

(54) CHANNEL OCCUPANCY TIME SHARING ELIGIBILITY

(71) Applicant: QUALCOMM Incorporated, San Diego, CA (US)

(72) Inventors: Chih-Hao LIU, San Diego, CA (US); Jing SUN, San Diego, CA (US); Giovanni CHISCI, San Diego, CA (US); Stelios STEFANATOS, San Diego, CA (US); Xiaoxia ZHANG, San Diego, CA (US)

(21) Appl. No.: 18/499,161

(22) Filed: Oct. 31, 2023

Related U.S. Application Data
(60) Provisional application No. 63/382,582, filed on Nov. 7, 2022.

(51) Int. Cl. H04W 74/08

(52) U.S. Cl. CPC H04W 74/0808

(57) ABSTRACT

Various aspects of the present disclosure generally relate to wireless communication. In some aspects, a receiving user equipment (UE) may receive, from a transmitting UE, a first communication associated with a channel occupancy time (COT) of the transmitting UE and at least one of a cast type or a channel type. The UE may transmit a second communication in the COT of the transmitting UE based at least in part on the cast type or the channel type of the first communication. Numerous other aspects are described.

### CROSS-REFERENCE TO RELATED APPLICATION

This Patent Application claims priority to U.S. Provisional Patent Application No. 63/382,582, filed on Nov. 7, 2022, entitled “CHANNEL OCCUPANCY TIME SHARING ELIGIBILITY,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for channel occupancy time (COT) sharing eligibility.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a receiving user equipment (UE). The method may include receiving, from a transmitting UE, a first communication associated with a channel occupancy time (COT) of the transmitting UE and at least one of a cast type or a channel type. The method may include transmitting a second communication in the COT of the transmitting UE based at least in part on the cast type or the channel type of the first communication.

Some aspects described herein relate to a receiving UE for wireless communication. The receiving UE may include a memory and one or more processors coupled to the memory. The one or more processors may be configured to receive, from a transmitting UE, a first communication associated with a COT of the transmitting UE and at least one of a cast type or a channel type. The one or more processors may be configured to transmit a second communication in the COT of the transmitting UE based at least in part on the cast type or the channel type of the first communication.

Some aspects described herein relate to a non-transitory computer-readable medium that stores a set of instructions for wireless communication by a receiving UE. The set of instructions, when executed by one or more processors of the receiving UE, may cause the receiving UE to receive, from a transmitting UE, a first communication associated with a COT of the transmitting UE and at least one of a cast type or a channel type. The set of instructions, when executed by one or more processors of the receiving UE, may cause the UE to transmit a second communication in the COT of the transmitting UE based at least in part on the cast type or the channel type of the first communication.

Some aspects described herein relate to an apparatus for wireless communication. The apparatus may include means for receiving, from a transmitting UE, a first communication associated with a COT of the transmitting UE and at least one of a cast type or a channel type. The apparatus may include means for transmitting a second communication in the COT of the transmitting UE based at least in part on the cast type or the channel type of the first communication.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of sidelink communications, in accordance with the present disclosure.

FIGS. 4A and 4B are diagrams illustrating an example of sidelink communications and access link communications, in accordance with the present disclosure.

FIG. 5 is a diagram illustrating an example of signaling associated with channel occupancy time sharing based at least in part on a channel type and/or cast type, in accordance with the present disclosure.

FIG. 6 is a diagram illustrating an example process performed, for example, by a receiving UE, in accordance with the present disclosure.

FIG. 7 is a diagram of an example apparatus for wireless communication, in accordance with the present disclosure.

### DETAILED DESCRIPTION

User equipments (UEs) may communicate on spectrum that utilizes a channel access mechanism, such as an unlicensed channel. For example, prior to gaining access to and/or transmitting over a channel such as an unlicensed channel, a transmitting device may perform a listen-before-talk (LBT) procedure to contend for access to the unlicensed channel. The LBT procedure may generally include a clear channel assessment (CCA) procedure that is performed in order to determine whether the channel is available (e.g., unoccupied by other transmitters). In particular, the CCA procedure may include detecting an energy level on the channel and determining whether the energy level satisfies (e.g., is less than or equal to) a threshold, sometimes referred to as an energy detection threshold and/or the like. When the energy level satisfies (e.g., does not equal or exceed) the threshold, the CCA procedure is deemed to be successful, and the transmitting device may gain access to the channel for a duration that may be referred to as a channel occupancy time (COT) during which the transmitting device can perform transmissions without performing additional LBT operations. When the energy level does not satisfy the threshold, the CCA procedure is unsuccessful and contention to access the channel may be deemed unsuccessful.

In some deployments, UE-to-UE COT sharing may be enabled. For example, an initiating UE may perform transmissions, which may include one or more sidelink control information transmissions that indicate when an initial transmission will end, a remaining duration of the COT that is available for sharing, and/or the like. Accordingly, one or more responding UEs may monitor the sidelink control information transmitted by other UEs (e.g., the initiating UE) to recover COT sharing information that can be used to perform transmissions during a time period that corresponds to a shared COT.

Accordingly, UE-to-UE COT sharing may enable better access to unlicensed spectrum, more efficient usage of unlicensed spectrum, and/or the like by enabling multiple UEs to perform transmissions during a COT that is obtained by an initiating UE (e.g., a UE that successfully performed an LBT procedure to acquire access to an unlicensed channel). In some examples, a receiving UE may be permitted to share a COT of a transmitting UE if the receiving UE is a target receiver of the transmitting UE's COT transmission (that is, a transmission for which the transmitting UE acquired the COT or a transmission by the transmitting UE in the transmitting UE's COT).

UEs communicating on the sidelink may communicate using different channel types (e.g., physical sidelink feedback channel (PSFCH), physical sidelink shared channel (PSSCH), physical sidelink control channel (PSCCH), or sidelink synchronization signal block (S-SSB)) and/or different cast types (e.g., unicast, groupcast, or broadcast, described elsewhere herein). There may be situations in which COT sharing, without regard for a cast type or channel type of a transmitting UE's COT transmission, leads to crowding of the channel or failures of communications. For example, a broadcast transmission may reach all UEs within a range of a transmitting UE, but it may be impractical for each of the UEs within the range of the transmitting UE to share the transmitting UE's COT. As another example, if a receiving UE transmitting on a physical channel such as a PSFCH, a PSSCH, or a PSCCH is permitted to share a COT for an S-SSB transmission, channel crowding may result.

Some techniques described herein provide COT sharing between a transmitting UE and a receiving UE based at least in part on a channel type and/or a cast type of a first communication (e.g., a COT transmission) of the transmitting UE. For example, a receiving UE may receive a first communication associated with a COT of the transmitting UE and at least one of a cast type or a channel type. The receiving UE may transmit a second communication in the COT (e.g., may perform COT sharing with the transmitting UE's COT) based at least in part on the cast type or the channel type of the communication. For example, the second communication may have a cast type and/or channel type that is permitted for COT sharing with the first communication. In this way, crowding of the channel and failures of communications between sidelink UEs are reduced.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

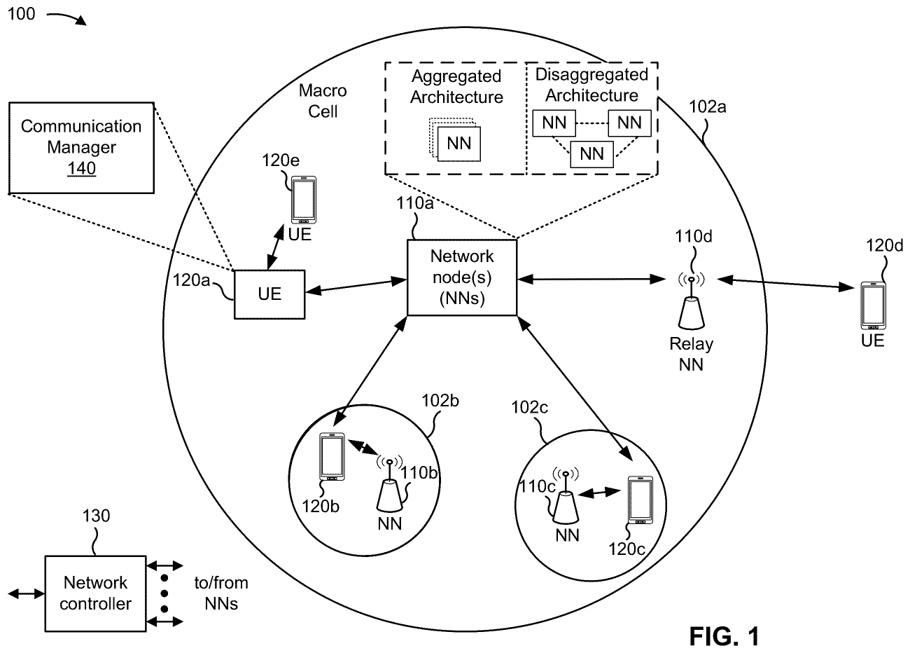

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a transmitting UE, a first communication associated with a COT of the transmitting UE and at least one of a cast type or a channel type; and transmit a second communication in the COT of the transmitting UE based at least in part on the cast type or the channel type of the first communication. Additionally, or alternatively, the communication manager 140 may perform one or more other operations described herein.

As indicated above, FIG. 1 is provided as an example. Other examples may differ from what is described with regard to FIG. 1.

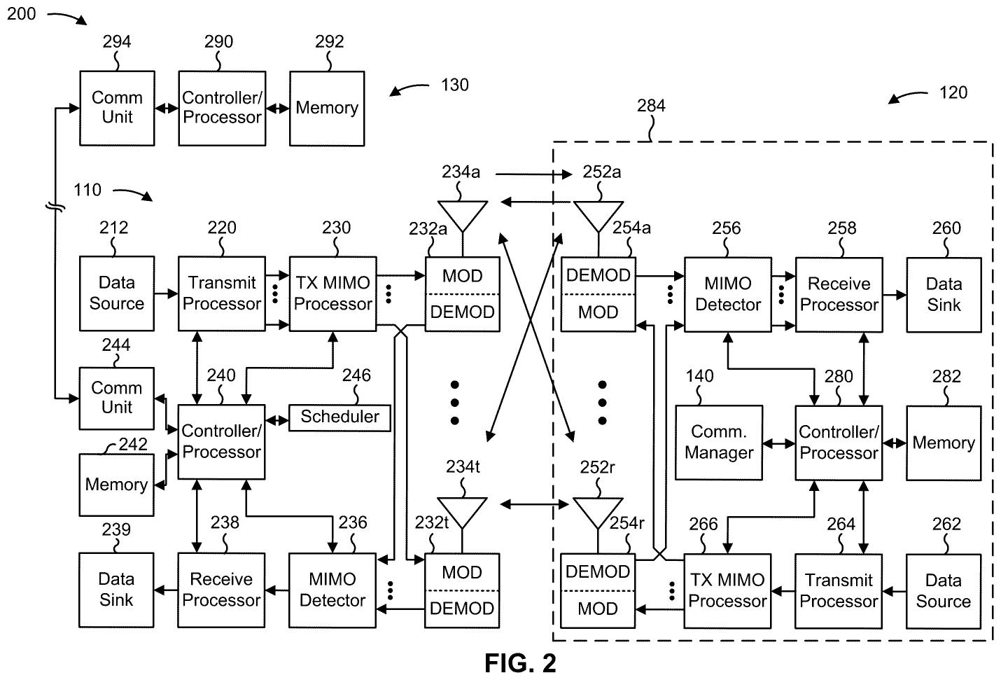

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

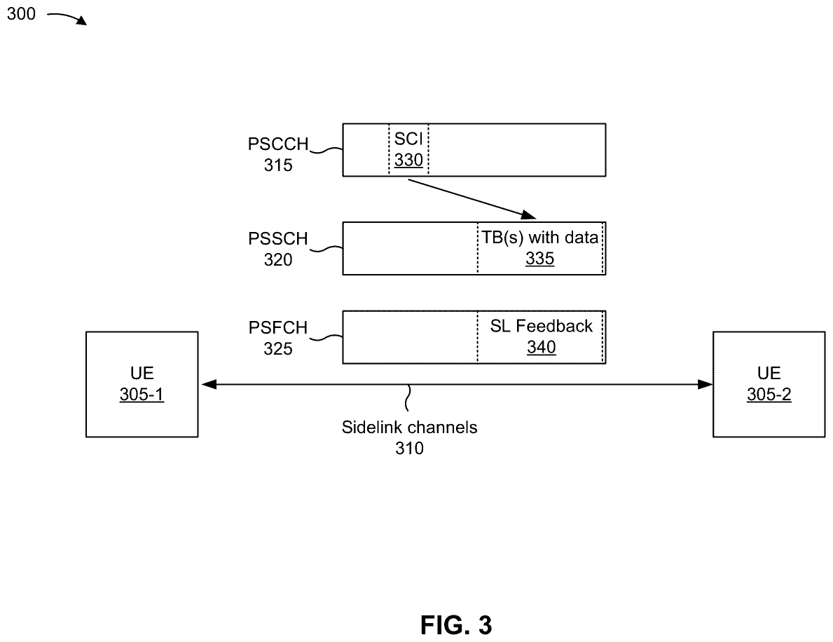

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-7).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-7).

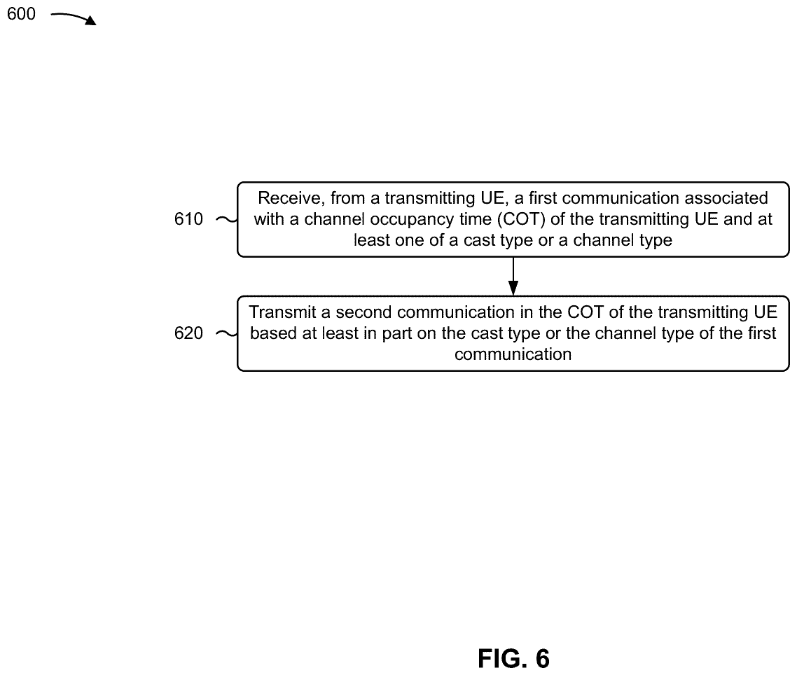

The controller/processor 240 of the network node 110, the controller/processor 280 of the UE 120, and/or any other component(s) of FIG. 2 may perform one or more techniques associated with COT sharing, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6 and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6 and/or other processes as described herein. In some examples, executing instructions may include running the instructions, converting the instructions, compiling the instructions, and/or interpreting the instructions, among other examples.

In some aspects, a receiving UE includes means for receiving, from a transmitting UE, a first communication associated with a COT of the transmitting UE and at least one of a cast type or a channel type; and/or means for transmitting a second communication in the COT of the transmitting UE based at least in part on the cast type or the channel type of the first communication. The means for the receiving UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a network node 110 via an access link or an access channel. The PSSCH 320 may be used to communicate data, similar to a physical downlink shared channel (PDSCH) and/or a physical uplink shared channel (PUSCH) used for cellular communications with a network node 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QoS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 320, such as a HARQ process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a sidelink transmission mode (e.g., Mode 1) where resource selection and/or scheduling is performed by a network node 110 (e.g., a base station, a CU, or a DU). For example, the UE 305 may receive a grant (e.g., in downlink control information (DCI) or in a radio resource control (RRC) message, such as for configured grants) from the network node 110 (e.g., directly or via one or more network nodes) for sidelink channel access and/or scheduling. In some aspects, a UE 305 may operate using a transmission mode (e.g., Mode 2) where resource selection and/or scheduling is performed by the UE 305 (e.g., rather than a network node 110). In some aspects, the UE 305 may perform resource selection and/or scheduling by sensing channel availability for transmissions. For example, the UE 305 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy ratio (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or an MCS to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As indicated above, FIG. 3 is provided as an example. Other examples may differ from what is described with respect to FIG. 3.

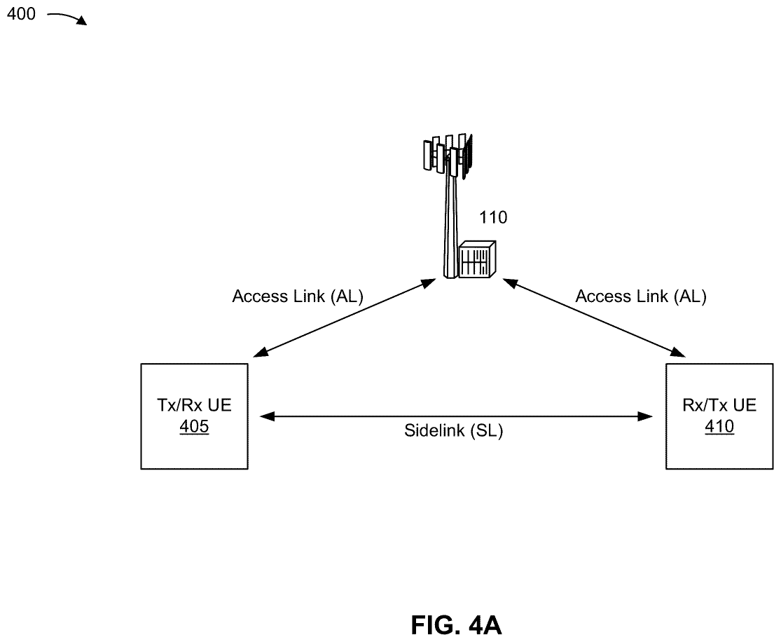

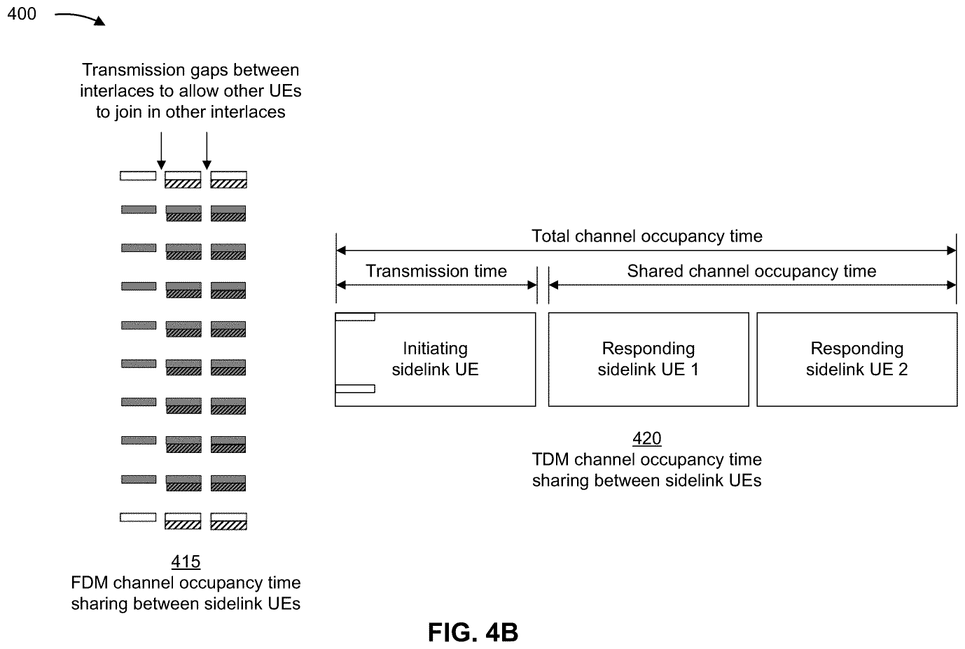

FIGS. 4A and 4B are diagrams illustrating examples 400 of sidelink communications and access link communications, in accordance with the present disclosure.

As shown in FIG. 4A, a transmitter (Tx)/receiver (Rx) UE 405 and an Rx/Tx UE 410 may communicate with one another via a sidelink, as described above in connection with FIG. 3. As further shown, in some sidelink modes, a network node 110 may communicate with the Tx/Rx UE 405 (e.g., directly or via one or more network nodes), such as via a first access link. Additionally, or alternatively, in some sidelink modes, the network node 110 may communicate with the Rx/Tx UE 410 (e.g., directly or via one or more network nodes), such as via a second access link. The Tx/Rx UE 405 and/or the Rx/Tx UE 410 may correspond to one or more UEs described elsewhere herein, such as the UE 120 of FIG. 1 or the UE 305 of FIG. 3. Thus, a direct link between UEs 120 (e.g., via a PC5 interface) may be referred to as a sidelink, and a direct link between a network node 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

For example, to accommodate increasing traffic demands, there have been various efforts to improve spectral efficiency in wireless networks and thereby increase network capacity (e.g., via use of higher order modulations, advanced MIMO antenna technologies, multi-cell coordination techniques, and/or the like). Another way to potentially improve network capacity is to expand system bandwidth. However, available spectrum in lower frequency bands that have traditionally been licensed or otherwise allocated to mobile network operators may be limited.

Accordingly, various technologies have been developed to enable operation of a cellular RAT in unlicensed or other shared spectrum. For example, Licensed-Assisted Access (LAA) uses carrier aggregation on a downlink to combine LTE in a licensed frequency band with LTE in an unlicensed frequency band (e.g., the 2.4 and/or 5 GHz bands already populated by wireless local area network (WLAN) or “Wi-Fi” devices). As another example, Enhanced LAA (eLAA) and Further Enhanced LAA (feLAA) technologies enable both uplink and downlink LTE operation in unlicensed spectrum. As another example, MulteFire is an LTE-based technology that operates in unlicensed and shared spectrum in a standalone mode. As another example, NR-U enables NR operation in unlicensed spectrum. In general, when operating a cellular RAT in unlicensed spectrum (e.g., using LAA, eLAA, feLAA, MulteFire, and/or NR-U), one challenge that arises is the need to ensure fair coexistence with incumbent (e.g., WLAN) systems that may be operating in the unlicensed spectrum.

For example, prior to gaining access to and/or transmitting over a channel such as an unlicensed channel, a transmitting device (e.g., network node 110, UE 120, UE 405, UE 410, and/or the like) may perform a listen-before-talk (LBT) procedure to contend for access to the unlicensed channel. The LBT procedure may generally include a clear channel assessment (CCA) procedure that is performed in order to determine whether the channel is available (e.g., unoccupied by other transmitters). In particular, the CCA procedure may include detecting an energy level on the channel and determining whether the energy level satisfies (e.g., is less than or equal to) a threshold, sometimes referred to as an energy detection threshold and/or the like. When the energy level satisfies (e.g., does not equal or exceed) the threshold, the CCA procedure is deemed to be successful, and the transmitting device may gain access to the channel for a duration that may be referred to as a channel occupancy time (COT) during which the transmitting device can perform transmissions without performing additional LBT operations. When the energy level does not satisfy the threshold, the CCA procedure is unsuccessful and contention to access the channel may be deemed unsuccessful.

When the CCA procedure results in a determination that the channel band is unavailable (e.g., because the energy level detected on the channel indicates that another device is already using the channel), the CCA procedure may be performed again at a later time. In environments in which the transmitting device may obtain limited access to a channel (e.g., due to WLAN activity or transmissions by other devices), an extended CCA (eCCA) procedure may be employed to increase the likelihood that the transmitting device will successfully obtain access to the channel.

For example, a transmitting device performing an eCCA procedure may perform a random quantity of CCA procedures (from 1 to q), in accordance with an eCCA counter. If and/or when the transmitting device senses that the channel has become clear, the transmitting device may start a random wait period based on the eCCA counter and start to transmit if the channel remains clear over the random wait period.

Accordingly, although a wireless network can be configured to use unlicensed spectrum to achieve faster data rates, provide a more responsive user experience, offload traffic from a licensed spectrum, and/or the like, ensuring fair coexistence with incumbent systems (e.g., WLAN devices) may be balanced with efficient usage of the unlicensed spectrum. For example, even when there is no interference, the LBT procedure used to ensure that no other devices are already using the channel introduces a delay before transmissions can start, which may degrade user experience, result in unacceptable performance for latency-sensitive or delay-sensitive applications, and/or the like. Furthermore, these problems may be exacerbated when the initial CCA procedure is unsuccessful, as the transmitting device can transmit on the channel only after performing an additional quantity of CCA procedures and determining that the channel has become clear and remained clear for a random wait period. Furthermore, in some cases, the COT obtained by a transmitting device may have a duration that is longer than necessary for the transmitting device to perform the desired transmissions, which may lead to inefficient usage of the unlicensed channel.

Accordingly, in some cases, a wireless network may enable a COT obtained by a transmitting device to be shared with other nodes in order to improve access and efficiency for an unlicensed channel. For example, in downlink-to-uplink COT sharing over an access link, a network node 110 may acquire a COT with an eCCA, and the COT may be shared with one or more UEs (e.g., UE 120, UE 405, UE 410, and/or the like) that can then transmit uplink signals within the COT acquired by the network node 110. In this case, a UE attempting to initiate an uplink transmission within the COT shared with the network node 110 can perform an uplink transmission without having to perform an LBT procedure, or the UE may perform the uplink transmission after performing a single-shot CCA with a shorter LBT procedure (e.g., a category 2 LBT procedure when the downlink-to-uplink gap duration is between 16 and 25 μs, a category 1 LBT procedure when a downlink-to-uplink gap duration is less than or equal to 16 μs, and/or the like).

Additionally, or alternatively, a wireless network may support uplink-to-downlink COT sharing over an access link. In this case, a UE-initiated COT (e.g., for a configured grant PUSCH or a scheduled uplink transmission) can be shared with the network node 110. In this way, the network node 110 may be allowed to transmit control and/or broadcast signals and/or channels for any UE served by the network node 110, provided that the transmission contains a downlink signal, channel, and/or other transmission (e.g., a PDSCH, PDCCH, reference signal, and/or the like) intended to be received by the UE that initiated the channel occupancy.

Additionally, or alternatively, a wireless network may support UE-to-UE COT sharing over a sidelink. For example, as shown in FIG. 4B, and by reference number 415, a COT acquired by an initiating UE (e.g., UE 405) may be shared in a frequency division multiplexing (FDM) mode by dividing the COT into multiple interlaces (e.g., time periods during which one or more UEs may perform transmit operations). For example, as shown in FIG. 4B, the initiating UE may use one or more sidelink resources (e.g., time and frequency resources) to transmit in a first interlace after the COT has been acquired, and a responding UE (e.g., UE 410) may use sidelink frequency resources that are non-overlapping with sidelink frequency resources used by the initiating UE to perform transmit operations in subsequent interlaces. Accordingly, as shown in FIG. 4B, FDM or interlace-based COT sharing may introduce short transmission gaps between interlaces to allow other UEs to perform transmit operations in subsequent interlaces during a shared COT, and sidelink control information transmitted by the initiating UE may carry information to support the interlace-based COT sharing. The initiating UE may be referred to herein as a transmitting UE, and the responding UE(s) may be referred to as receiving UE(s).

Additionally, or alternatively, as shown by reference number 420, UE-to-UE COT sharing may be enabled in a time division multiplexing (TDM) mode. In this case, the total COT may be divided into an initial time period during which the initiating UE may perform transmissions, which may include one or more sidelink control information transmissions that indicate when the initial transmission will end, a remaining duration of the COT that is available for sharing, and/or the like. Accordingly, one or more responding UEs may monitor the sidelink control information transmitted by other UEs (e.g., the initiating UE) to recover COT sharing information that can be used to perform transmissions during a time period that corresponds to a shared COT.

Accordingly, as described above, UE-to-UE COT sharing may enable better access to unlicensed spectrum, more efficient usage of unlicensed spectrum, and/or the like by enabling multiple UEs to perform transmissions during a COT that is obtained by an initiating UE (e.g., a UE that successfully performed an LBT procedure to acquire access to an unlicensed channel). In some examples, a receiving UE may be permitted to share a COT of a transmitting UE if the receiving UE is a target receiver of the transmitting UE's COT transmission (that is, a transmission for which the transmitting UE acquired the COT or a transmission by the transmitting UE in the transmitting UE's COT).

UEs communicating on the sidelink may communicate using different channel types (e.g., PSFCH, PSSCH, PSCCH, or sidelink synchronization signal block (S-SSB)) and/or different cast types (e.g., unicast, groupcast, or broadcast, described elsewhere herein). There may be situations in which COT sharing, without regard for a cast type or channel type of a transmitting UE's COT transmission, leads to crowding of the channel or failures of communications. For example, a broadcast transmission may reach all UEs within a range of a transmitting UE, but it may be impractical for each of the UEs within the range of the transmitting UE to share the transmitting UE's COT. As another example, if a receiving UE transmitting on a physical channel such as a PSFCH, a PSSCH, or a PSCCH is permitted to share a COT for an S-SSB transmission, channel crowding may result.

Some techniques described herein provide COT sharing between a transmitting UE and a receiving UE based at least in part on a channel type and/or a cast type of a first communication (e.g., a COT transmission) of the transmitting UE. For example, a receiving UE may receive a first communication associated with a COT of the transmitting UE and at least one of a cast type or a channel type. The receiving UE may transmit a second communication in the COT (e.g., may perform COT sharing with the transmitting UE's COT) based at least in part on the cast type or the channel type of the communication. For example, the second communication may have a cast type and/or channel type that is permitted for COT sharing with the first communication. In this way, crowding of the channel and failures of communications between sidelink UEs are reduced.

As indicated above, FIGS. 4A and 4B are provided as examples. Other examples may differ from what is described with regard to FIGS. 4A and 4B.

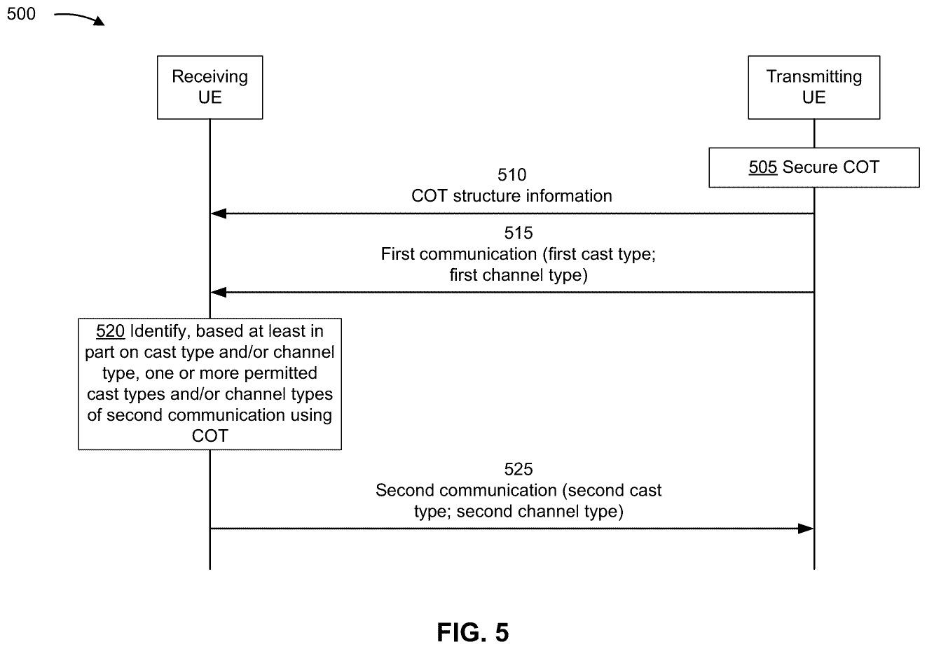

FIG. 5 is a diagram illustrating an example 500 of signaling associated with COT sharing based at least in part on a channel type and/or cast type, in accordance with the present disclosure. As shown, example 500 includes a transmitting UE (e.g., UE 120, UE 405, UE 410) and a receiving UE (e.g., UE 120, UE 405, UE 410).

As shown in FIG. 5, and by reference number 505, the transmitting UE may acquire a COT during which the transmitting UE is permitted to transmit over an unlicensed channel. In some aspects, the transmitting UE may successfully perform an LBT procedure to acquire the COT. For example, prior to gaining access to, and transmitting over, the unlicensed channel, the transmitting UE may perform the LBT procedure to contend for access to the unlicensed channel. In some aspects, the LBT procedure may include a CCA procedure that the transmitting UE performs to determine whether the unlicensed channel is available (e.g., unoccupied by other transmitters). In some aspects, the transmitting UE may detect an energy level on the unlicensed channel, and the CCA procedure may be determined to be successful if the energy level on the unlicensed channel satisfies (e.g., is less than or equal to) a threshold. In such cases, the transmitting UE may gain access to the unlicensed channel to acquire the COT during which the transmitting UE can perform transmissions without performing additional LBT operations.

In cases where the energy level detected on the unlicensed channel fails to satisfy (e.g., is greater than or equal to the threshold), the CCA procedure may be determined to be unsuccessful, and the transmitting UE may perform the CCA procedure again and acquire the COT at a later time. Additionally, or alternatively, the transmitting UE may acquire the COT by performing another type of channel access procedure. For example, the transmitting UE may acquire the COT by performing an extended CCA (eCCA) procedure.

As shown by reference number 510, the receiving UE may receive COT structure information. For example, the transmitting UE may transmit COT structure information based at least in part on acquiring the COT. The COT structure information may indicate a resource structure (e.g., time resources and/or frequency resources) of the COT.

As shown by reference number 515, the transmitting UE may transmit, and the receiving UE may receive, a first communication. In some aspects, the first communication may enable the sharing of the COT acquired by the transmitting UE (e.g., the first communication may include a COT sharing indication). In some aspects, the COT sharing indication may be included in sidelink control information (e.g., SCI-1 or SCI-2) transmitted by the transmitting UE to a group of one or more UEs (e.g., a group of UEs that includes the receiving UE). In some aspects, the receiving UE may be a target receiver of the first communication. For example, the first communication may indicate an identifier of the receiving UE as a target receiver.

As shown, the first communication may have a first channel type. For example, the first channel type may be a PSCCH channel type (e.g., the first communication may be transmitted on a PSCCH, such as SCI-1 on a PSCCH). As another example, the first channel type may be a PSSCH channel type (e.g., the first communication may be transmitted on a PSSCH, such as SCI-2 and/or a data payload such as a transport block on a PSSCH). As another example, the first channel type may be a PSFCH channel type (e.g., the first communication may be transmitted on a PSFCH, such as feedback on the PSFCH regarding a sidelink communication). For example, the first channel type may be a S-SSB channel type (e.g., the first communication may be or include an S-SSB). In some aspects, the first communication may have multiple channel types. For example, the first communication may include multiple communications, such as multiple transmissions by the transmitting UE in the COT. Each communication, of the multiple communications, may have a respective channel type. As just one example, the first communication may include a first transmission with a PSFCH channel type and a second transmission with a PSSCH channel type.

As shown, the first communication may have a first cast type. A cast type may indicate whether the first communication is a unicast transmission, a groupcast transmission, or a broadcast transmission. For example, a cast type can be a unicast type, a groupcast type, or a broadcast type. A unicast transmission is a transmission from a single transmitting UE to a single receiving UE, such as based at least in part on a transmitter identifier of the transmitting UE and a receiver identifier of the receiving UE. A groupcast transmission is a transmission from a single transmitting UE to a group of (one or more) receiving UEs. A groupcast transmission can be a connectionless groupcast transmission or a managed groupcast transmission. A groupcast transmission may be directed to a group of UEs according to a group identifier of the group of UEs. A broadcast transmission is a transmission from a single transmitting UE to all receiving UEs within a range of the transmitting UE. For example, the broadcast transmission may indicate a range parameter that identifies whether a receiving UE is within the range of the transmitting UE. As another example, all UEs capable of decoding the broadcast transmission may receive the broadcast transmission. In some aspects, the first communication may have multiple cast types. For example, the first communication may include multiple transmissions, and each transmission of the multiple transmissions may have a respective cast type.

As shown by reference number 520, the receiving UE may identify, based at least in part on the cast type and/or the channel type, one or more permitted cast types and/or channel types of a second communication using the COT. For example, the receiving UE may identify one or more permitted cast types and/or one or more permitted channel types that can share the COT of the transmitting UE.

In some aspects, the receiving UE may receive configuration information indicating the one or more permitted cast types and/or the one or more permitted channel types. The configuration information can be received from a network node (e.g., via RRC or other semi-static signaling), via a UE profile or other static signaling or configuration, or the like. For example, the configuration information may indicate a table. In some aspects, the table may indicate a first cast type of the first communication and one or more second cast types that are permitted for the second communication (for the purpose of COT sharing between the first communication and the second communication). Additionally, or alternatively, the table may indicate a first channel type of the first communication and one or more second channel types that are permitted for the second communication (for the purpose of COT sharing between the first communication and the second communication). Thus, the receiving UE may be eligible for COT sharing using limited cast types and/or limited channel types based at least in part on a cast type and/or channel type of the first communication.

Table 1 is an example table indicating permissible second cast types for a second communication in view of first cast types of a first communication. Each row corresponds to a first cast type. Each column corresponds to a second cast type. “Yes” indicates that a second communication of the indicated second cast type can be transmitted using COT sharing in a COT of (e.g., obtained for) a first communication of the indicated first cast type. In some aspects, Table 1 may be a lower triangular matrix in which the lower triangle is occupied by “Yes,” such that the receiving UE does not use COT sharing to transmit to more UEs than the transmitting UE's intention.

TABLE 1

| | Second cast | Second cast | Second cast |
|---|---|---|---|
| | type: Unicast | type: Groupcast | type: Broadcast |
| First cast type: | Yes | No | No |
| Unicast | | | |
| First cast type: | Yes | Yes | No |
| Groupcast | | | |
| First cast type: | Yes | Yes | No |
| Broadcast | | | |

Table 2 is an example table indicating permissible second channel types for a second communication in view of first channel types of a first communication. Each row corresponds to a first channel type. Each column corresponds to a second channel type. “Yes” indicates that a second communication of the indicated second channel type can be transmitted using COT sharing in a COT of (e.g., obtained for) a first communication of the indicated first channel type.

TABLE 2

| | Second | Second | Second |
|---|---|---|---|
| | channel type: | channel type: | channel type: |
| | PSCCH/PSSCH | PSFCH | S-SSB |
| First channel type: | Yes | Yes | Yes |
| PSCCH/PSSCH | | | |
| First cast type: | No, or only for | No | Yes |
| PSFCH | retransmissions | | |
| First cast type: S-SSB | No | No | Yes |

For example, if the transmitting UE transmits a unicast communication to the receiving UE, the receiving UE may only be able to transmit unicast data back to the transmitting UE according to Table 1 (e.g., based at least in part on the first communication being a unicast communication and the receiving UE being a target of the first communication). Thus, COT sharing by the receiving UE for groupcast or broadcast communications (such as to transmit PSSCH to other non-COT initiating UEs) is avoided. As another example, if the transmitting UE transmits a first groupcast transmission to the receiving UE (e.g., to a group of UEs including the receiving UE), the receiving UE may be permitted to transmit unicast communications only to the transmitting UE, or may be permitted to transmit unicast communications as well as groupcast communications to a group of UEs including the transmitting UE (e.g., a same group of UEs as the group of UEs to which the first groupcast transmission was transmitted). This may facilitate acknowledgement of the first groupcast transmission, or may facilitate subsequent group-based communications among the group of UEs. In some aspects, if the receiving UE transmits a groupcast communication using COT sharing with a first communication, target receivers of the groupcast communication may be the same as the target receivers of the first communication, which ensures that the groupcast communication is only for the target receiver of the transmitting UE's first communication. If the transmitting UE transmits a broadcast communication to the receiving UE, the receiving UE may be permitted to transmit unicast communications only, unicast or groupcast communications only, or unicast, groupcast, and broadcast communications including the transmitting UE.

In some aspects, the receiving UE may only be eligible for COT sharing with a first communication of certain channel types based at least in part on the first communication's channel type(s). For example, second communications having channel types that may carry important information (e.g., S-SSB or PSFCH) may be permitted to share the COT with a first communication having a PSSCH channel type. As another example, a second communication with an S-SSB channel type may be permitted to share a COT with a first communication having a PSFCH channel type. As another example, a second communication carrying a PSSCH retransmission (e.g., having a PSSCH channel type) may share a COT with a first communication having a PSFCH channel type. As another example, a second communication having an S-SSB channel type may be permitted to share a COT with a first communication having an S-SSB channel type when the transmitting UE is a synchronization reference node of the receiving UE (e.g., a node from which the receiving UE's sidelink timing and/or frequency alignment is derived).

In some aspects, the first communication or the transmitting UE may include an indication of a cast type or a channel type for a second communication. For example, the COT structure information may indicate a permitted cast type and/or a permitted channel type for the second communication, such as by reference to a semi-statically configured table. Thus, the transmitting UE can down-select the cast type and/or channel type of a second communication of the receiving UE utilizing COT sharing with the transmitting UE.

In some aspects, the one or more permitted cast types and/or channel types may be based at least in part on multiple channel types and/or multiple cast types of the first communication. For example, the first communication may have multiple channel types and/or multiple cast types. In this example, the receiving UE may select a cast type and/or a channel type based at least in part on the multiple channel types and/or the multiple cast types. For example, the receiving UE may select a cast type from all cast types permitted for COT sharing with any cast type of the multiple cast types (e.g., if the first communication includes both groupcast and unicast transmissions to the receiving UE, then the receiving UE may select groupcast as a reference cast type in Table 1, which allows the receiving UE to choose either unicast or groupcast for COT sharing). As another example, the receiving UE may select a channel type from all channel types permitted for COT sharing with any channel type of the multiple channel types. For example, if the first communication includes both PSSCH and PSFCH transmissions to the receiving UE, then the receiving UE may select PSSCH as a reference channel type in Table 2, which allows the receiving UE to select a PSSCH channel type, a PSFCH channel type, a PSCCH channel type, or an S-SSB channel type for COT sharing.

As shown by reference number 525, the receiving UE may transmit the second communication in the COT of the transmitting UE. The receiving UE may transmit the second communication based at least in part on the cast type and/or the channel type of the first communication. For example, the second communication may have a cast type that is permitted for COT sharing with first communications having a cast type of the first communication. As another example, the second communication may have a channel type that is permitted for COT sharing with first communications having a channel type of the first communication. In some aspects, the second communication may be directed to the transmitting UE. For example, the transmitting UE may be a target receiver of the second communication, or the transmitting UE may belong to a group of UEs to which the second communication is directed. In some aspects, the receiving UE may transmit an indication of COT sharing with the transmitting UE.

As indicated above, FIG. 5 is provided as an example. Other examples may differ from what is described with regard to FIG. 5.

FIG. 6 is a diagram illustrating an example process 600 performed, for example, by a receiving UE, in accordance with the present disclosure. Example process 600 is an example where the receiving UE (e.g., UE 120, UE 405, UE 410, the receiving UE of FIG. 5) performs operations associated with channel occupancy time sharing eligibility.

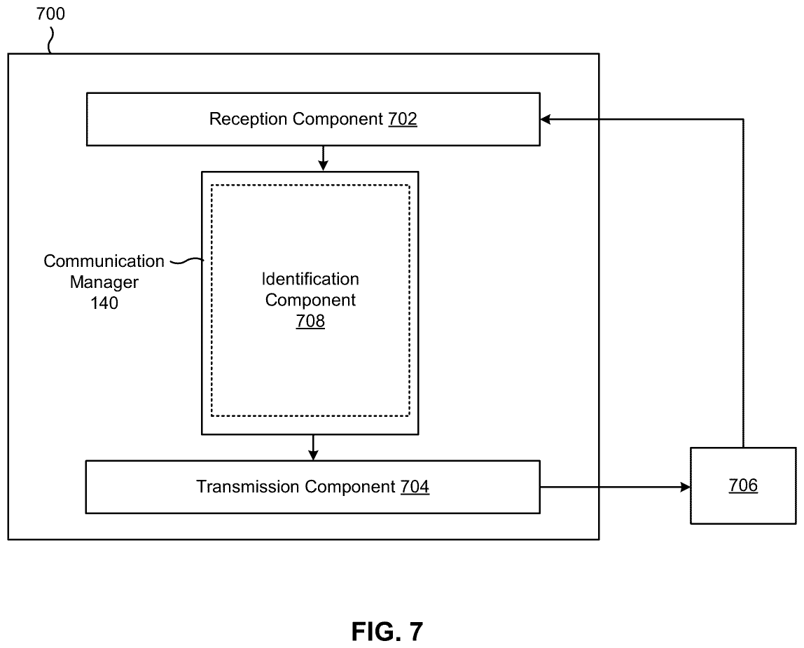

As shown in FIG. 6, in some aspects, process 600 may include receiving, from a transmitting UE, a first communication associated with a COT of the transmitting UE and at least one of a cast type or a channel type (block 610). For example, the receiving UE (e.g., using communication manager 140 and/or reception component 702, depicted in FIG. 7) may receive, from a transmitting UE, a first communication associated with a COT of the transmitting UE and at least one of a cast type or a channel type, as described above, for example, in connection with reference number 515 of FIG. 5.

As further shown in FIG. 6, in some aspects, process 600 may include transmitting a second communication in the COT of the transmitting UE based at least in part on the cast type or the channel type of the first communication (block 620). For example, the UE (e.g., using communication manager 140 and/or transmission component 704, depicted in FIG. 7) may transmit a second communication in the COT of the transmitting UE based at least in part on the cast type or the channel type of the first communication, as described above, for example, in connection with reference number 525 of FIG. 5.

Process 600 may include additional aspects, such as any single aspect or any combination of aspects described below and/or in connection with one or more other processes described elsewhere herein.

In a first aspect, the second communication is associated with a same cast type as the first communication.

In a second aspect, alone or in combination with the first aspect, the first communication is associated with a groupcast cast type, and the second communication is associated with a unicast cast type or the groupcast cast type based at least in part on the first communication being associated with the groupcast cast type.

In a third aspect, alone or in combination with one or more of the first and second aspects, the first communication is associated with a unicast cast type, and the second communication is associated with the unicast cast type based at least in part on the first communication being associated with the unicast cast type.

In a fourth aspect, alone or in combination with one or more of the first through third aspects, the first communication is associated with a broadcast cast type, and the second communication is associated with a unicast cast type or a groupcast cast type based at least in part on the first communication being associated with the broadcast cast type.

In a fifth aspect, alone or in combination with one or more of the first through fourth aspects, the second communication is associated with a groupcast cast type and is directed to a UE group including the transmitting UE.

In a sixth aspect, alone or in combination with one or more of the first through fifth aspects, the first communication is also directed to the UE group including the transmitting UE, and the UE group includes the receiving UE.

In a seventh aspect, alone or in combination with one or more of the first through sixth aspects, process 600 includes receiving a configuration indicating one or more permitted cast types for the second communication, wherein the one or more permitted cast types are based at least in part on the cast type associated with the first communication.

In an eighth aspect, alone or in combination with one or more of the first through seventh aspects, the first communication indicates one or more permitted cast types for the second communication.

In a ninth aspect, alone or in combination with one or more of the first through eighth aspects, a COT structure indicator of the first communication indicates the one or more permitted cast types.

In a tenth aspect, alone or in combination with one or more of the first through ninth aspects, the first communication is associated with multiple cast types including the cast type, and the method further comprises selecting a cast type for the second communication based at least in part on the multiple cast types.

In an eleventh aspect, alone or in combination with one or more of the first through tenth aspects, the channel type is a first channel type, and the second communication has a second channel type based at least in part on the first channel type.

In a twelfth aspect, alone or in combination with one or more of the first through eleventh aspects, the first channel type is a physical sidelink shared channel type and the second channel type is a sidelink synchronization signal block channel type or a feedback channel type.

In a thirteenth aspect, alone or in combination with one or more of the first through twelfth aspects, the first channel type is a feedback channel type and the second channel type is a sidelink synchronization signal block channel type.

In a fourteenth aspect, alone or in combination with one or more of the first through thirteenth aspects, the first channel type is a sidelink synchronization signal block type and the second channel type is the sidelink synchronization signal block channel type.

In a fifteenth aspect, alone or in combination with one or more of the first through fourteenth aspects, the transmitting UE is a synchronization reference node of the receiving UE.

In a sixteenth aspect, alone or in combination with one or more of the first through fifteenth aspects, process 600 includes receiving a configuration indicating one or more permitted channel types for the second communication, wherein the one or more permitted channel types are based at least in part on the first channel type associated with the first communication.

In a seventeenth aspect, alone or in combination with one or more of the first through sixteenth aspects, the first communication is associated with multiple channel types including the first channel type, and the method further comprises selecting the second channel type for the second communication based at least in part on the multiple channel types.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication, in accordance with the present disclosure. The apparatus 700 may be a UE, or a UE may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include the communication manager 140. The communication manager 140 may include one or more of an identification component 708, among other examples.

In some aspects, the apparatus 700 may be configured to perform one or more operations described herein in connection with FIGS. 4A, 4B, and 5. Additionally, or alternatively, the apparatus 700 may be configured to perform one or more processes described herein, such as process 600 of FIG. 6, or a combination thereof. In some aspects, the apparatus 700 and/or one or more components shown in FIG. 7 may include one or more components of the UE described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the UE described in connection with FIG. 2.

The transmission component 704 may transmit communications, such as reference signals, control information, data communications, or a combination thereof, to the apparatus 706. In some aspects, one or more other components of the apparatus 700 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, a memory, or a combination thereof, of the UE described in connection with FIG. 2. In some aspects, the transmission component 704 may be co-located with the reception component 702 in a transceiver.

The reception component 702 may receive, from a transmitting UE, a first communication associated with a COT of the transmitting UE and at least one of a cast type or a channel type. The transmission component 704 may transmit a second communication in the COT of the transmitting UE based at least in part on the cast type or the channel type of the first communication. For example, the second communication may use a channel type and/or cast type identified by the identification component 708 based at least in part on the cast type or the channel type of the first communication, as described herein.

The reception component 702 may receive a configuration (sometimes referred to herein as configuration information) indicating one or more permitted cast types for the second communication, wherein the one or more permitted cast types are based at least in part on the cast type associated with the first communication.

The reception component 702 may receive a configuration (sometimes referred to herein as configuration information) indicating one or more permitted channel types for the second communication, wherein the one or more permitted channel types are based at least in part on the first channel type associated with the first communication.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The following provides an overview of some Aspects of the present disclosure:

Aspect 1: A method of wireless communication performed by a receiving user equipment (UE), comprising: receiving, from a transmitting UE, a first communication associated with a channel occupancy time (COT) of the transmitting UE and at least one of a cast type or a channel type; and transmitting a second communication in the COT of the transmitting UE based at least in part on the cast type or the channel type of the first communication.

Aspect 2: The method of Aspect 1, wherein the second communication is associated with a same cast type as the first communication.

Aspect 3: The method of any of Aspects 1-2, wherein the first communication is associated with a groupcast cast type, and wherein the second communication is associated with a unicast cast type or the groupcast cast type based at least in part on the first communication being associated with the groupcast cast type.

Aspect 4: The method of any of Aspects 1-3, wherein the first communication is associated with a unicast cast type, and wherein the second communication is associated with the unicast cast type based at least in part on the first communication being associated with the unicast cast type.

Aspect 5: The method of any of Aspects 1-4, wherein the first communication is associated with a broadcast cast type, and wherein the second communication is associated with a unicast cast type or a groupcast cast type based at least in part on the first communication being associated with the broadcast cast type.

Aspect 6: The method of any of Aspects 1-5, wherein the second communication is associated with a groupcast cast type and is directed to a UE group including the transmitting UE.

Aspect 7: The method of Aspect 6, wherein the first communication is also directed to the UE group including the transmitting UE, and wherein the UE group includes the receiving UE.

Aspect 8: The method of any of Aspects 1-7, further comprising receiving a configuration indicating one or more permitted cast types for the second communication, wherein the one or more permitted cast types are based at least in part on the cast type associated with the first communication.

Aspect 9: The method of any of Aspects 1-8, wherein the first communication indicates one or more permitted cast types for the second communication.

Aspect 10: The method of Aspect 9, wherein a COT structure indicator of the first communication indicates the one or more permitted cast types.

Aspect 11: The method of any of Aspects 1-10, wherein the first communication is associated with multiple cast types including the cast type, and the method further comprises selecting a cast type for the second communication based at least in part on the multiple cast types.

Aspect 12: The method of any of Aspects 1-11, wherein the channel type is a first channel type, and wherein the second communication has a second channel type based at least in part on the first channel type.

Aspect 13: The method of Aspect 12, wherein the first channel type is a physical sidelink shared channel type and the second channel type is a sidelink synchronization signal block channel type or a feedback channel type.

Aspect 14: The method of Aspect 12, wherein the first channel type is a feedback channel type and the second channel type is a sidelink synchronization signal block channel type.

Aspect 15: The method of Aspect 12, wherein the first channel type is a sidelink synchronization signal block type and the second channel type is the sidelink synchronization signal block channel type.

Aspect 16: The method of Aspect 15, wherein the transmitting UE is a synchronization reference node of the receiving UE.

Aspect 17: The method of Aspect 12, further comprising receiving a configuration indicating one or more permitted channel types for the second communication, wherein the one or more permitted channel types are based at least in part on the first channel type associated with the first communication.

Aspect 18: The method of Aspect 12, wherein the first communication is associated with multiple channel types including the first channel type, and the method further comprises selecting the second channel type for the second communication based at least in part on the multiple channel types.

Aspect 19: An apparatus for wireless communication at a device, comprising a processor; memory coupled with the processor; and instructions stored in the memory and executable by the processor to cause the apparatus to perform the method of one or more of Aspects 1-18.

Aspect 20: A device for wireless communication, comprising a memory and one or more processors coupled to the memory, the one or more processors configured to perform the method of one or more of Aspects 1-18.

Aspect 21: An apparatus for wireless communication, comprising at least one means for performing the method of one or more of Aspects 1-18.

Aspect 22: A non-transitory computer-readable medium storing code for wireless communication, the code comprising instructions executable by a processor to perform the method of one or more of Aspects 1-18.

Aspect 23: A non-transitory computer-readable medium storing a set of instructions for wireless communication, the set of instructions comprising one or more instructions that, when executed by one or more processors of a device, cause the device to perform the method of one or more of Aspects 1-18.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A receiving user equipment (UE) for wireless communication, comprising:
one or more memories; and
one or more processors, coupled to one or more memories, individually or collectively configured to:
receive, from a transmitting UE, a first communication associated with a channel occupancy time (COT) of the transmitting UE and at least one of a cast type or a channel type; and
transmit a second communication in the COT of the transmitting UE based at least in part on at least one of the cast type or the channel type of the first communication.

2. The receiving UE of claim 1, wherein the second communication is associated with a same cast type as the first communication.

3. The receiving UE of claim 1, wherein the first communication has a groupcast cast type, and wherein the second communication has a unicast cast type or the groupcast cast type based at least in part on the first communication having the groupcast cast type.

4. The receiving UE of claim 1, wherein the first communication has a unicast cast type, and wherein the second communication has the unicast cast type based at least in part on the first communication having the unicast cast type.

5. The receiving UE of claim 1, wherein the first communication has a broadcast cast type, and wherein the second communication has a unicast cast type or a groupcast cast type based at least in part on the first communication having the broadcast cast type.

6. The receiving UE of claim 1, wherein the second communication has a groupcast cast type and is directed to a UE group including the transmitting UE.

7. The receiving UE of claim 6, wherein the first communication is also directed to the UE group including the transmitting UE, and wherein the UE group includes the receiving UE.

8. The receiving UE of claim 1, wherein the one or more processors are individually or collectively configured to receive a configuration indicating one or more permitted cast types for the second communication, wherein the one or more permitted cast types are based at least in part on the cast type associated with the first communication.

9. The receiving UE of claim 1, wherein the first communication indicates one or more permitted cast types for the second communication.

10. The receiving UE of claim 9, wherein a COT sharing indication of the first communication indicates the one or more permitted cast types.

11. The receiving UE of claim 1, wherein the first communication is associated with multiple cast types including the cast type, and the one or more processors are individually or collectively configured to select a cast type for the second communication based at least in part on the multiple cast types.

12. The receiving UE of claim 1, wherein the channel type is a first channel type, and wherein the second communication has a second channel type based at least in part on the first channel type.

13. The receiving UE of claim 12, wherein the first channel type is a physical sidelink shared channel type and the second channel type is a sidelink synchronization signal block channel type or a feedback channel type.

14. The receiving UE of claim 12, wherein the first channel type is a feedback channel type and the second channel type is a sidelink synchronization signal block channel type.

15. The receiving UE of claim 12, wherein the first channel type is a sidelink synchronization signal block type and the second channel type is the sidelink synchronization signal block channel type.

16. The receiving UE of claim 15, wherein the transmitting UE is a synchronization reference node of the receiving UE.

17. The receiving UE of claim 12, wherein the one or more processors are individually or collectively configured to receive a configuration indicating one or more permitted channel types for the second communication, wherein the one or more permitted channel types are based at least in part on the first channel type associated with the first communication.

18. The receiving UE of claim 12, wherein the first communication is associated with multiple channel types including the first channel type, and the one or more processors are further configured to select the second channel type for the second communication based at least in part on the multiple channel types.

19. A method of wireless communication performed by a receiving user equipment (UE), comprising:
receiving, from a transmitting UE, a first communication associated with a channel occupancy time (COT) of the transmitting UE and at least one of a cast type or a channel type; and
transmitting a second communication in the COT of the transmitting UE based at least in part on at least one of the cast type or the channel type of the first communication.

20. The method of claim 19, wherein the second communication is associated with a same cast type as the first communication.

21. The method of claim 19, wherein the first communication is associated with a groupcast cast type, and wherein the second communication is associated with a unicast cast type or the groupcast cast type based at least in part on the first communication being associated with the groupcast cast type.

22. The method of claim 19, wherein the first communication is associated with a unicast cast type, and wherein the second communication is associated with the unicast cast type based at least in part on the first communication being associated with the unicast cast type.

23. The method of claim 19, wherein the second communication is associated with a groupcast cast type and is directed to a UE group including the transmitting UE.

24. The method of claim 19, wherein the first communication indicates one or more permitted cast types for the second communication.

25. The method of claim 24, wherein a COT sharing indication of the first communication indicates the one or more permitted cast types.

26. The method of claim 19, wherein the first communication is associated with multiple cast types including the cast type, and the method further comprises selecting a cast type for the second communication based at least in part on the multiple cast types.

27. The method of claim 19, wherein the channel type is a first channel type, and wherein the second communication has a second channel type based at least in part on the first channel type.

28. The method of claim 27, wherein the first channel type is a physical sidelink shared channel type and the second channel type is a sidelink synchronization signal block channel type or a feedback channel type.

29. A non-transitory computer-readable medium storing a set of instructions for wireless communication, the set of instructions comprising:
one or more instructions that, when executed by one or more processors of a receiving user equipment (UE), cause the UE to:
receive, from a transmitting UE, a first communication associated with a channel occupancy time (COT) of the transmitting UE and at least one of a cast type or a channel type; and
transmit a second communication in the COT of the transmitting UE based at least in part on at least one of the cast type or the channel type of the first communication.

30. An apparatus for wireless communication, comprising:
means for receiving, from a transmitting user equipment (UE), a first communication associated with a channel occupancy time (COT) of the transmitting UE and at least one of a cast type or a channel type; and
means for transmitting a second communication in the COT of the transmitting UE based at least in part on at least one of the cast type or the channel type of the first communication.
